(19) United States
(12) Patent Application Publication
(10) Pub. No.: US 2026/0160327 A1
(43) Pub. Date: Jun. 11, 2026

(54) Differential Gearing for a Vehicle and Drive Unit with an Electrical Machine and a Differential Gearing

(71) Applicant: ZF Friedrichshafen AG, Friedrichshafen (DE)

(72) Inventors: Matthias REISCH, Ravensburg (DE); Christopher ALLNOCH, Kressbronn (DE); Christoph GRADL, Markdorf (DE); Petra HÖWNER, Friedrichshafen (DE)

(21) Appl. No.: 19/129,074

(22) PCT Filed: Oct. 9, 2023
(86) PCT No.: PCT/EP2023/077829

§ 371 Date: May 12, 2025

(30) Foreign Application Priority Data
Nov. 10, 2022 (DE) 10 2022 211 903.7

(51) Int. Cl. F16H 57/04; B60K 1/00; B60K 17/16; F16H 48/10

(52) U.S. Cl. CPC F16H 57/0483; B60K 1/00; B60K 17/165; F16H 48/10; F16H 57/0424; F16H 57/0427; F16H 57/0436; F16H 57/046; F16H 57/0479; B60K 2001/001; F16H 2048/104; F16H 2048/106; F16H 57/0409; F16H 57/0447; F16H 57/0457

(57) ABSTRACT

A vehicle differential transmission includes a drive shaft, first and second output shafts each operatively drivingly connected to a wheel, first and second planetary gear sets, an oil catchment device, and an oil feeding device. Each of the first and second planetary gear sets has a sun shaft, a ring gear shaft, and a carrier shaft. Exactly one of the shafts of the first planetary gear set is rotationally fixedly connected to exactly one of the output shafts. Exactly one of the shafts of the second planetary gear set is rotationally fixedly connected to exactly one of the output shafts. The oil catchment device is rotationally fixedly connected to the first carrier shaft. The oil feeding device is arranged on a stationary component and defines at least one channel for feeding lubricant to the oil catchment device via non-rotating components.

### CROSS-REFERENCE TO RELATED APPLICATION

The present application is related and has right of priority to German Patent Application No. 10 2022 211 903.7 filed on Nov. 10, 2022, and is a nationalization of PCT/EP 2023/077829 filed in the European Patent Office on Oct. 9, 2023, both of which are incorporated by reference in their entirety for all purposes.

### FIELD OF THE INVENTION

The invention relates generally to a differential transmission for a vehicle. Furthermore, the invention relates generally to a drive unit having an electric machine and such a differential transmission.

### BACKGROUND

DE 10 2011 108 170 A1 discloses a motor vehicle having an internal combustion engine, an electric machine, and a housing which surrounds at least one planetary transmission, wherein the planetary transmission couples the internal combustion engine and the electric machine to one another and has at least one sun gear, one planet carrier, one planet gear, and one ring gear. The planetary transmission has its own circulating lubrication system which includes a lubricant reservoir, a bore system in a part of the housing for transporting a lubricant to at least one component of the planetary transmission, a feed of the lubricant to a contact point between two parts of the planetary transmission which are movable relative to one another, and a rotating drive element for the lubricant, which is a constituent part of the planetary transmission, for accelerating the lubricant.

Lubricant is used for cooling and lubrication in transmissions. In planetary transmissions, the lubricant is generally guided via rotatable shafts. Via distribution bores in the shafts, the lubricant is fed, for example, axially in the region of an oil catchment device of the planet carrier for cooling and lubrication to the planet gears and planet bearings. Disadvantages are associated with this form of lubricant guidance. For example, the feed of the lubricant into the shaft frequently requires additional sealing elements, such as rectangular rings, which are arranged on the shaft. In particular, the costs for the transmission are increased as a result. Furthermore, the feed of the lubricant into the shaft frequently causes additional axial overall length since more installation space is required for the additional components. Furthermore, bores in the shaft weaken the shaft and therefore reduce the achievable power density of the transmission. Drag torques are caused by the feed of the lubricant into the shaft, as a result of which energy consumption increases and the range of the vehicle decreases.

### SUMMARY OF THE INVENTION

The object of the present invention is to provide an alternative differential transmission for a vehicle, wherein the differential transmission is intended to be constructed in particular in a compact and cost-effective manner. In particular, the supply of the differential transmission with lubricant and the lubricant guidance in the housing of the differential transmission are intended to be optimized.

A differential transmission according to the invention for a vehicle has a drive shaft which is configured to be operatively drivingly connected to an electric machine, a first output shaft and a second output shaft which are each configured to be operatively drivingly connected to a wheel of the vehicle, and at least one first planetary gear set with a first sun shaft, a first ring gear shaft, and a first carrier shaft, wherein exactly one of the shafts of the first planetary gear set is rotationally fixedly connected to exactly one of the two output shafts, an oil catchment device which is rotationally fixedly connected to the first carrier shaft, and an oil feeding device which is arranged on a stationary component and has at least one channel for feeding lubricant to the oil catchment device via non-rotating components.

An “operative drivingly connection” is to be understood to mean that further components, in particular shafts, gearwheels and/or shifting elements, may be arranged between the components which are operatively drivingly connected to one another. For example, the drive shaft is rotationally fixedly connected to the rotor of the electric machine, wherein the electric machine introduces a drive power into the differential transmission. The drive power of the electric machine is distributed to the two wheels of the axle of the vehicle via the two output shafts. The respective output shaft may be connected to the associated wheel directly or directly or indirectly or indirectly via a joint, a joint shaft, and/or a wheel hub.

Within the meaning of the invention, a “shaft” is to be understood to mean a rotatable component of the transmission via which in each case associated components of the transmission are rotationally fixedly connected to one another or via which such a connection may be produced when one of the shifting elements is actuated. In this case, the respective shaft may connect the components to one another axially or radially or also both axially and radially. Thus, the respective shaft may also be present as an intermediate piece via which a respective component is connected radially, for example. In this case, the term “shaft” does not rule out the possibility that the components to be connected may be provided in one piece. In particular, two or more shafts which are rotationally fixedly connected to one another may be provided in one piece.

For example, the first sun shaft is configured as a drive of the first planetary gear set. Preferably, the first sun shaft is rotationally fixedly connected to the drive shaft. The first carrier shaft is configured to rotate, that is to say is not fixed in a stationary manner. Preferably, the first carrier shaft is rotationally fixedly connected to exactly one of the two output shafts. In particular, the first carrier shaft is rotationally fixedly connected to the first output shafts. Further preferably, the first ring gear shaft is configured to rotate, that is to say is not fixed in a stationary manner. Thus, the first carrier shaft and the first ring gear shaft form the output of the first planetary gear set.

An “oil catchment device” is to be understood to mean a device which is provided in one piece or in multiple parts and is for catching lubricant for the first planetary gear set. The caught lubricant is fed to the first carrier shaft for lubrication and cooling of elements arranged thereon. By virtue of the fact that the oil catchment device is rotationally fixedly connected to the first carrier shaft, lubricant may be fed efficiently to the first carrier shaft by centrifugal forces, wherein the supply of lubricant to the planet gears and the planet bearings of the first planetary gear set is realized thereof. The planet gears of the first planetary gear set are in toothed engagement with the sun shaft and the ring gear shaft.

In the context of this invention, a “lubricant” is to be understood to mean a means for lubrication and cooling of toothings which are in toothed engagement with one another and of the bearing elements. For example, oil or an oil mixture is suitable as a lubricant.

The oil feeding device defines at least one channel, that is to say a fluid line which is configured for guiding lubricant. For example, further channels, preferably for cooling the electric machine and/or for lubrication and cooling further toothings, may be branched off from the at least one channel. The oil feeding device is arranged on a stationary component, that is to say a non-rotating component. A “stationary component” is to be understood to mean a component which is fixed in a stationary manner, in particular is rotationally fixedly connected or is connected in one piece to a part of a housing. Thus, the lubricant is guided directly via the non-rotating component to the oil catchment device, with the result that no otherwise customary rotating shafts are required for the passage of lubricant. In particular, costs are reduced as a result, since the passage of lubricant through shafts frequently requires additional sealing elements, such as rectangular rings. Furthermore, the differential transmission can be formed in a more compact manner, since overall length and components for sealing the shafts are dispensed with. Furthermore, the power density of the differential transmission is increased, since shafts are not weakened by lubricant bores and drag losses due to lubricant in the shafts are dispensed with.

According to a preferred embodiment, the differential transmission further includes a second planetary gear set with a second sun shaft, a second ring gear shaft, and a second carrier shaft, wherein exactly one of the shafts of the second planetary gear set is rotationally fixedly connected to exactly one of the two output shafts. Preferably, another one of the shafts of the second planetary gear set is rotationally fixedly connected to exactly one of the shafts of the first planetary gear set. Preferably, another one of the shafts of the second planetary gear set is rotationally fixedly connected to a stationary component. For example, the second sun shaft is rotationally fixedly connected to the first ring gear shaft. For example, the second ring gear shaft is rotationally fixedly connected to the second output shaft. For example, the second carrier shaft is rotationally fixedly connected to the stationary component, and therefore prevented from rotating.

The second planetary gear set is arranged radially nested with respect to the first planetary gear set, wherein the first planetary gear set is arranged radially inside and the second planetary gear set is arranged radially outside. The two planetary gear sets together form an integral differential.

In the context of this invention, an “integral differential” is to be understood to mean a differential having a first planetary gear set and a second planetary gear set, wherein the first planetary gear set is operatively drivingly connected to the drive shaft, to the second planetary gear set, and to the first output shaft. The second planetary gear set is operatively drivingly connected to a second output shaft. At identical output rotational speeds of the output shafts, the integral differential has no toothing which runs circumferentially in the block or runs circumferentially without a rolling movement. Thus, a relative movement of the components of the integral differential which are in toothed engagement with one another always takes place independently of the output rotational speeds of the output shafts. With an integral differential, the sums of the two wheel torques are not combined or combined to form a common axle torque in a rotating component, but rather a drive power is divided in the integral differential and passed on into the output shafts operatively connected thereto according to the design of the first and second planetary gear sets. Thus, the components of the integral differential may be designed to be slimmer on account of the respective, comparatively small torque. In addition, a component reduction and a weight saving are realized. By such an integral differential, the two functions of torque conversion and torque distribution, which have generally been achieved by two separate assemblies, may be represented by a single integral assembly. The integral differential is therefore a combined transmission and differential transmission which realizes, on the one hand, a torque conversion and, on the other hand, the torque distribution to the output shafts.

According to a preferred embodiment, the oil catchment device has or defines at least one at least partially circumferential ring element. For example, the oil catchment device is provided in one piece and annularly circumferentially on the first carrier shaft. Alternatively, the oil catchment device is provided in multiple parts and is arranged on the first carrier shaft in such a way that lubricant can be fed via the respective planet pins of the planet gears of the first planetary gear set. In particular, a plurality of partially circumferential pocket-shaped ring elements on the first carrier shaft form the oil catchment device.

According to a preferred embodiment, the oil feeding device is at least partially integrated in the stationary component. In other words, the oil feeding device is part of the stationary component, for example part of the housing or of an element rotationally fixedly connected to the housing. Alternatively, the oil feeding device is a separate component which is arranged on the stationary component. For example, the oil feeding device is formed from a metal or a plastic.

According to a preferred embodiment, the at least one channel is formed by at least one bore in the stationary component. Thus, the at least one channel is produced by machining. Alternatively, the at least one channel is produced by casting. Preferably, the at least one channel is at least partially formed substantially obliquely in the radial direction in the stationary component. In other words, the at least one channel runs obliquely or at an angle or tilted with respect to an axis formed in the radial direction with respect to an axis of rotation of the first planetary gear set. In particular, the at least one channel is formed by boring in a housing wall, wherein the bore is arranged obliquely in the housing wall in such a way that it can be bored obliquely from radially outside or radially inside. As a result, the production of the oil feeding device is facilitated and at the same time the lubricant distribution is improved. Preferably, the at least one channel is at least partially formed substantially in the axial direction in the stationary component. Thus, the at least one channel runs at least partially axially parallel to the axis of rotation of the first planetary gear set. In particular, the at least one channel may be formed slightly at an angle to the axis of rotation of the first planetary gear set.

According to a preferred embodiment, the oil feeding device is fluidly connected to a pump which is for feeding lubricant into the oil feeding device. The lubricant collects, for example, on the housing base of the differential transmission and is sucked in from the housing base by the pump and fed to the oil feeding device. In particular, a lubricant sump is formed on the housing base of the differential transmission. Further components, in particular heat exchangers and/or filter elements, may be arranged in a feed line of the pump. Advantageously, the volume flow of the lubricant is set by a control unit, as a result of which reliable lubrication and cooling are realized. In particular, oil filters and heat exchangers may be arranged effectively in the lubricant circuit. Furthermore, the oil level on the housing base of the differential transmission may be lowered in order to minimize a drag torque as a result of splashing.

Alternatively, or additionally, the oil feeding device is fluidly connected to a catchment channel which is for feeding lubricant into the oil feeding device. A rotating component of the differential transmission, for example the second ring gear shaft, dips into lubricant which has collected on the housing base of the differential transmission and carries said lubricant along an intermediate space with respect to the housing, wherein the lubricant is caught by the catchment channel and fed from there to the oil feeding device. Advantageously, a pump may be dispensed with in the case of a sufficient amount of lubricant on the housing base of the differential transmission, as a result of which costs and weight may be saved.

According to a preferred embodiment, the oil feeding device defines an annular channel for receiving and distributing lubricant. The pump and/or the catchment channel conveys the lubricant directly into said annular channel which is a lubricant space and which is preferably formed between the housing and the second carrier shaft. The lubricant is advantageously distributed via the annular channel. In particular, the annular channel is formed circumferentially in the circumferential direction.

Preferably, the annular channel is fluidly connected to the at least one channel and at least one lubricating bore on the second planetary gear set. In particular, the at least one lubricating bore is formed in the planet pins of the planet gears of the second planetary gear set, wherein said planet pins are arranged on the second carrier shaft. The second carrier shaft is rotationally fixedly arranged on the stationary component where the annular channel is formed. The at least one channel and the at least one lubricating bore are fed with lubricant from the annular channel.

In order to be able to mount the second carrier shaft in a simple manner and at the same time to ensure a secure, rotationally fixedly connected connection with respect to the stationary component configured as a housing, the second carrier shaft is preferably rotationally fixedly secured with respect to the stationary component via a driving toothing. The driving toothing is provided in particular to secure the second carrier shaft against rotation. Therefore, a torque of the differential transmission is supported on the stationary component via the second carrier shaft and the driving toothing. The driving toothing is preferably produced by casting, as a result of which the production costs may be reduced. In particular, the driving toothing includes a toothing on the second carrier shaft and a toothing on the stationary component which are in positive engagement with one another. The driving toothing is preferably arranged on an axial frontal side of the second carrier shaft. Preferably, the driving toothing is arranged within the annular channel configured as a lubricant space. In this case, a lubricant film may form between the teeth of the respective toothing which come into contact, which lubricant film has a positive effect in particular on the acoustic properties of the differential transmission.

According to a preferred embodiment, the oil feeding device defines at least one restriction. A “restriction” is to be understood to mean a local tapering which defines a smaller throughflow cross section than the throughflow cross section of the channel. The restriction effects an oil flow limitation and/or a targeted oil discharge from the channel. In particular, a lubricant pressure is set by the restriction. For example, the restriction is formed as a separate component, preferably as a sheet metal element or plastic element, and is arranged on the at least one channel. Alternatively, the restriction is formed as a bore with a smaller throughflow cross section than the throughflow cross section of the channel and is integrated in the at least one channel. According to a preferred embodiment, at least the first planetary gear set has helically toothed planetary gears, wherein the oil feeding device is configured to guide the lubricant into this helical toothing, wherein the helical toothing is configured to guide the lubricant from one frontal side of the planetary gear set to an opposite frontal side of the planetary gear set. Thus, the lubricant conveying effect of the helical toothing between the planetary gears and the sun shaft and ring gear shaft is used to transport the lubricant to further bearings which are located on the other frontal side of the planetary gears. In other words, the helical direction of the toothing and the direction of rotation of the planetary gears are coordinated with one another in such a way that the lubricant is conveyed away from the feeding point, axially through the toothed engagement on the planetary gear set, to further lubrication points and cooling points.

According to a preferred embodiment, the oil feeding device is configured to spray the lubricant at least through the first planetary gear set from one side of the planetary gear set onto an opposite side of the planetary gear set. In particular, during a rotation of the first carrier shaft, lubricant is sprayed through the air spaces which are formed in the circumferential direction between the respective planetary gears of the first planetary gear set, as a result of which the lubricant transport from the one side of the planetary gear set to the opposite side of the planetary gear set takes place particularly efficiently. Thus, a lubricant jet is generated on the at least one channel, for example by a restriction, which lubricant jet is guided through the planetary gear set substantially in the axial direction, preferably slightly inclined in the circumferential direction, in order to cool and lubricate elements on the opposite side of the planetary gear set. If the lubricant jet leaves the at least one channel in a slightly inclined manner, a smaller interruption can be achieved by the rotating planetary gears.

A drive unit according to the invention has an electric machine and a differential transmission according to the invention. A vehicle according to the invention has at least one drive unit according to the invention. The above definitions and statements relating to technical effects, advantages and advantageous embodiments of the differential transmission according to the invention likewise apply analogously to the drive unit according to the invention and to the vehicle according to the invention.

### BRIEF DESCRIPTION OF THE DRAWINGS

Advantageous embodiments of the invention, which are explained below, are illustrated in the drawings, wherein identical or similar elements are provided with the same reference signs. In the drawings:

FIG. 1 shows a highly abstracted schematic view of a vehicle having a drive axle which has a drive unit according to the invention;

FIG. 2 shows an abstracted schematic view of a drive unit according to the invention according to a first exemplary embodiment;

FIG. 3 shows a highly abstracted further schematic view of the drive unit according to the first exemplary embodiment;

FIG. 4 shows a highly abstracted schematic view of a drive unit according to the invention according to a second exemplary embodiment;

FIG. 5 shows an abstracted schematic view of a drive unit according to the invention according to a third exemplary embodiment; and

FIG. 6 shows an abstracted schematic view of a drive unit according to the invention according to a fourth exemplary embodiment.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

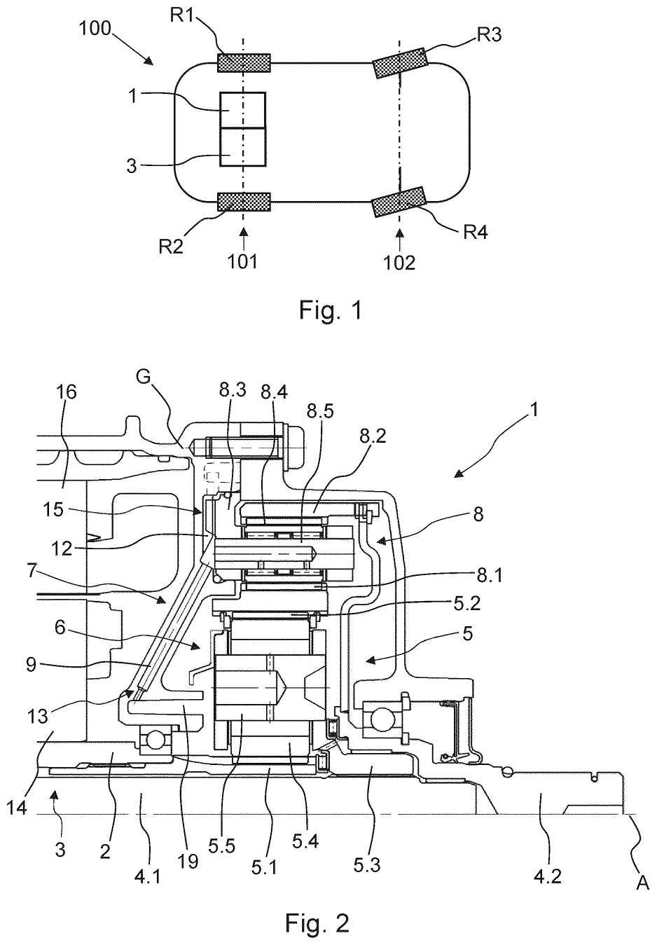

FIG. 1 shows a vehicle 100 having a first axle 101 including two vehicle wheels R1, R2, and a second axle 102 including two vehicle wheels R3, R4. In the present case, the first axle 101 is configured as a rear drive axle of the vehicle 100 and is equipped with a drive unit according to the invention. The drive unit has an electric machine 3 which is configured to generate a drive power, and a differential transmission 1 operatively drivingly connected thereto. Thus, the vehicle 100 is configured as an electric vehicle, i.e., as an electrically drivable vehicle. The drive unit is arranged transversely with respect to the vehicle longitudinal direction and is operatively drivingly connected to the vehicle wheels R1, R2 of the first axle 101. In the present case, no further drive unit is arranged on the second axle 102, that is to say on the front axle of the vehicle 100, as a result of which costs, weight and installation space are saved. Alternatively, the drive unit may be arranged on the front axle of the vehicle 100 instead of on the rear axle. In order to realize an all-wheel drive system, a further drive unit may be arranged on the second axle 102 and be operatively drivingly connected to the vehicle wheels R3, R4 of said axle 102.

FIG. 2 shows a detail of the drive unit, wherein, in the present case, the focus is on the differential transmission 1. The differential transmission 1 has a drive shaft 2 which is operatively drivingly connected to the electric machine 3, a first output shaft 4.1 and a second output shaft 4.2 which are each configured to be operatively drivingly connected to a wheel R1, R2 of the vehicle 100 shown in FIG. 1, a first planetary gear set 5 and a second planetary gear set 8, and an oil feeding device 7 and an oil catchment device 6 interacting therewith.

The first planetary gear set 5 has a first sun shaft 5.1, a first ring gear shaft 5.2, and a first carrier shaft 5.3 with a plurality of first planet gears 5.4 rotatably arranged on first planet pins 5.5, wherein the first planet gears 5.4 are in toothed engagement with the first sun shaft 5.1 and the first ring gear shaft 5.2. The second planetary gear set 8 has a second sun shaft 8.1, a second ring gear shaft 8.2, and a second carrier shaft 8.3 with a plurality of second planet gears 8.4 rotatably arranged on second planet pins 8.5, wherein the second planet gears 8.4 are in toothed engagement with the second sun shaft 8.1 and the second ring gear shaft 8.2. The two planetary gear sets 5, 8 are arranged in a radially stacked or nested manner, rotate about a common axis of rotation A, and form an integral differential. In the present case, the electric machine 3 is formed coaxially with respect to the differential transmission 1, wherein the drive shaft 2 is a hollow shaft and the first output shaft 4.1 is guided axially through the differential transmission 1 and the electric machine 3.

The first sun shaft 5.1 is rotationally fixedly connected to the drive shaft 2, wherein the drive shaft 2 is rotationally fixedly connected to a rotor 14 of the electric machine 3. The rotor 14 rotates within a stator 16, of the electric machine 3, the stator 16 being fixed with respect to the housing. The first ring gear shaft 5.2 is rotationally fixedly connected to the second sun shaft 8.1. In the present case, the first ring gear shaft 5.2 and the second sun shaft 8.1 form an intermediate gear with an inner toothing and an outer toothing, wherein the intermediate gear is configured as a coupling shaft between the two planetary gear sets 5, 8 and connects the two planetary gear sets 5, 8 to one another. The first carrier shaft 5.3 is rotationally fixedly connected to the first output shaft 4.1. The second ring gear shaft 8.2 is rotationally fixedly connected to the second output shaft 4.2. The second carrier shaft 8.3 is rotationally fixedly connected to a stationary component configured as a housing G. Thus, the second carrier shaft 8.3 is prevented from rotating. For this purpose, a driving toothing 15 is formed between the housing G and the second carrier shaft 8.3.

The oil feeding device 7 is integrated in the stationary component, configured as the housing G, and defines a channel 9 for feeding lubricant to the oil catchment device 6 via non-rotating components. In other words, the lubricant is guided without detours via rotating components, such as shafts, through the channel 9 in the housing G to the oil catchment device 6. The oil catchment device 6 is rotationally fixedly connected to the first carrier shaft 5.3 and therefore rotates together with the first carrier shaft 5.3. In the present case, the oil catchment device 6 is configured as a circumferential ring element and is configured for catching and introducing lubricant into the first planet pins 5.5. The lubricant is distributed via lubricant bores in the first planet pin 5.5 to the planet bearings of the first planet gears 5.4, to axial thrust washers, and to the toothings, in order to cool and lubricate them. In the present case, a substantial portion of the channel 9 is formed by a bore in the stationary component, wherein this bore is formed substantially obliquely in the radial direction in the stationary component. In particular, this bore has an angle of inclination of 30° with respect to an axis formed perpendicularly to the axis of rotation A. Furthermore, a further portion of the channel 9 is formed substantially in the axial direction, i.e., axially parallel to the axis of rotation A, in the stationary component, wherein this second portion is produced by casting as a housing recess 19. Costs are saved as a result. The oil feeding device 7 defines, between the two portions of the channel 9, a restriction 13 which is formed by tapering of the bore. Furthermore, the oil feeding device 7 defines an annular channel 12 for receiving and distributing lubricant. The annular channel 12 is arranged at the level of the second planetary gear set 8 and is formed axially between the housing G and the second carrier shaft 8.3. The driving toothing 15 is arranged in the annular channel 12. The annular channel 12 is fluidly connected to the channel 9 and the lubricating bore on the planet pins 8.5 of the second planetary gear set 8.

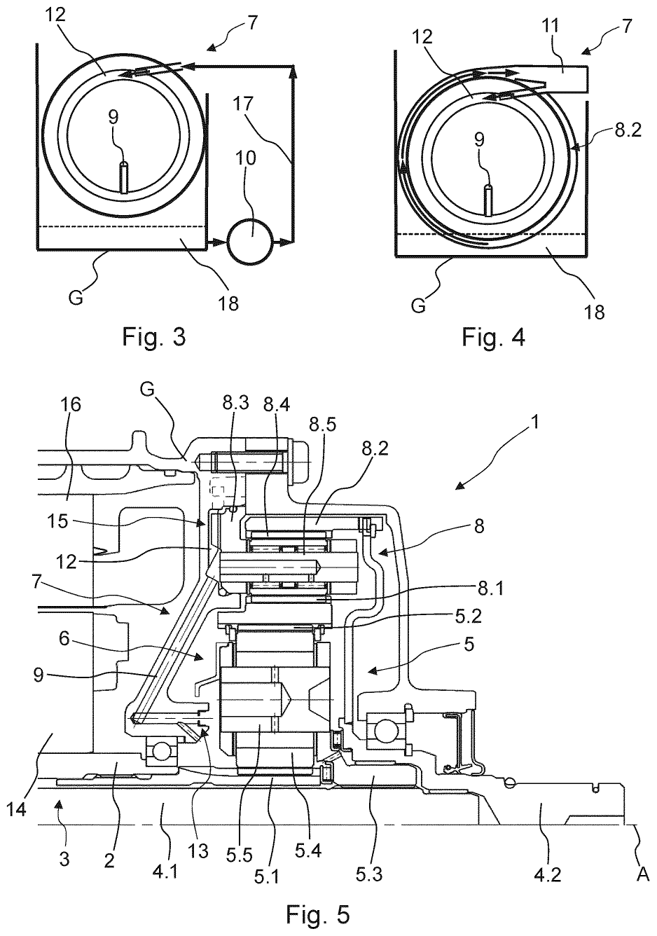

The lubricant is removed, for example, via a pump 10, which is illustrated in a simplified manner in FIG. 3, and lubricant lines 17 which interact therewith, from a lubricant reservoir 18 in the housing G and fed to the annular channel 12, which is illustrated in a highly simplified manner in FIG. 3. Thus, the oil feeding device 7 is fluidly connected to the pump 10 which is for feeding lubricant into the oil feeding device 7.

In FIG. 3, the lubricant flow is illustrated in a highly simplified manner by arrows. The annular channel 12 fluidly connects the second planet pins to one another and lubricates and cools the bearings of the second planet gears and also the thrust washers and toothing. Proceeding from this annular channel 12, the channel 9 of the oil feeding device 7 runs radially obliquely inwards in the direction of the axis of rotation A (FIG. 2). This is illustrated particularly well in FIG. 2. A tapering of the bore diameter serves as a restriction 13 for limiting the throughflow. The restriction 13 ends in the housing recess 19 produced by casting, from which the lubricant flows axially in the direction of the first carrier shaft 5.3. After leaving the stationary component configured as a housing G, the lubricant is collected by the oil catchment device 6 rotating with the first carrier shaft 5.3 and passed on into the lubricant bores to the first planet pin 5.5. From there, the lubricant cools and lubricates the planet bearings, then the axial thrust washers, and finally the toothing.

FIG. 4 shows a second embodiment of the drive device according to the invention. The drive device according to FIG. 4 substantially corresponds to the drive device according to FIG. 3, wherein there is a difference between these two embodiments in the arrangement of a catchment channel 11 instead of a pump. The catchment channel 11 is for feeding lubricant into the oil feeding device 7 and is fluidly connected to the oil feeding device 7. The lubricant flow is illustrated in a highly simplified manner in FIG. 4 by arrows. The second ring gear shaft 8.2 rotates clockwise and dips into the lubricant reservoir 18 in the housing G and carries the lubricant along an intermediate space with respect to the housing G. The lubricant is caught by the catchment channel 11 and fed to the annular channel 12 of the oil feeding device 7. As a result, the pump may be dispensed with, with the result that costs and weight may be saved. Otherwise, this exemplary embodiment corresponds to the exemplary embodiment according to FIG. 3, to which reference is made.

FIG. 5 shows a third embodiment of the drive device according to the invention. The drive device according to FIG. 5 substantially corresponds to the drive device according to FIG. 2, wherein there is a difference between these two embodiments in the axially formed portion of the channel 9. In the present case, the substantially axially formed portion of the channel 9 is not formed as a depression but as a bore. Furthermore, the restriction 13 is formed as a separate component at the end of the axially formed portion of the channel 9. Furthermore, a further oblique bore which is formed as a restriction with a smaller diameter is configured to spray lubricant from the axially formed portion of the channel 9 directly to the toothing between the first sun shaft 5.1 and the first planet gears 5.4. Both planetary gear sets 5, 8 have helically toothed planetary gears 5.4, 8.4. The oil feeding device 7 is configured to spray the lubricant into the helical toothing between the first sun shaft 5.1 and the first planet gears 5.4, wherein the helical toothing is configured to guide the lubricant from one frontal side of the planetary gear set 5 to an opposite frontal side of the planetary gear set 5. As a result, further bearings which are supplied with lubricant from the oil feeding device 7 on the other side of the first planetary gear set 5 may be supplied. Otherwise, the exemplary embodiment according to FIG. 5 corresponds to the exemplary embodiment according to FIG. 2, to which reference is made.

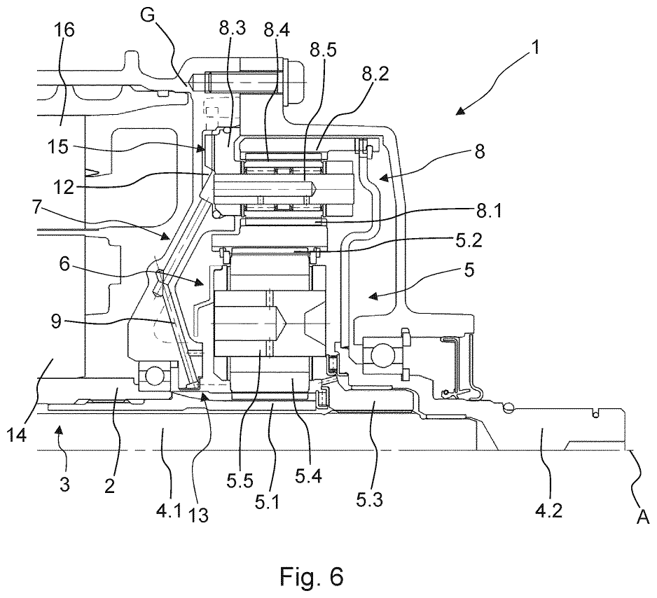

FIG. 6 shows a fourth embodiment of the drive device according to the invention. The drive device according to FIG. 6 substantially corresponds to the drive device according to FIG. 2, wherein there is a difference between these two embodiments in the channel 9. In the present case, the channel 9 is formed from two bores in the housing wall, wherein the bore portion of the channel 9 adjoining the annular channel 12 is arranged obliquely in the housing wall in such a way that it can be bored obliquely from radially outside, wherein the bore portion of the channel 9 adjoining the first planetary gear set 5 is arranged obliquely in the housing wall in such a way that it can be bored obliquely from radially inside. As a result, the production of the oil feeding device is facilitated and at the same time the lubricant distribution is improved. A restriction 13 configured as a separate element is arranged at an outlet opening which adjoins the first sun shaft 5.1. The oil feeding device 7 is configured to spray the lubricant via the restriction 13 through the first planetary gear set 5 from one side of the planetary gear set 5 onto the opposite side of the planetary gear set 5. In other words, the first planetary gears 5.4 move past in front of the lubricant jet which flows through the restriction 13. Whenever no first planetary gear 5.4 impedes the lubricant jet flow, lubricant can pass through between the first planetary gears 5.4 to the opposite side of the first planetary gear set 5. As a result, further bearings which are arranged on the other side of the first planetary gear set 5 may be supplied with lubricant from the oil feeding device 7. Furthermore, an additional lubricant flow is branched off through a further substantially axially formed bore to the oil catchment device 6. Otherwise, the exemplary embodiment according to FIG. 6 corresponds to the exemplary embodiment according to FIG. 2, to which reference is made.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings.

Such reference characters are provided for convenience only and have no effect on the scope of the claims. In particular, such reference characters are not intended to limit the claims to the particular example embodiments described in the detailed description and the drawings.

### REFERENCE SIGNS

1 differential transmission
2 drive shaft
3 electric machine
4.1 first output shaft
4.2 second output shaft
5 first planetary gear set
5.1 first sun shaft
5.2 first ring gear shaft
5.3 first carrier shaft
5.4 first planet gear
5.5 first planet pin
6 oil catchment device
7 oil feeding device
8 second planetary gear set
8.1 second sun shaft
8.2 second ring gear shaft
8.3 second carrier shaft
8.4 second planet gear
8.5 second planet pin
9 channel
10 pump
11 catchment channel
12 annular channel
13 restriction
14 rotor
15 driving toothing
16 stator
17 lubricant line
18 lubricant reservoir
19 housing recess
G housing
A axis of rotation
100 vehicle
101 first axle
102 second axle
R1 vehicle wheel
R2 vehicle wheel
R3 vehicle wheel
R4 vehicle wheel

1-15. (canceled)

16. A differential transmission (1) for a vehicle (100), comprising:
a drive shaft (2) which is configured to be operatively drivingly connected to an electric machine (3);
a first output shaft (4.1) and a second output shaft (4.2), each of the first output shaft (4.1) and the second output shaft (4.2) being configured to be operatively drivingly connected to a wheel (R1, R2) of the vehicle (100);
a first planetary gear set (5), the first planetary gear set (5) having a first sun shaft (5.1), a first ring gear shaft (5.2), and a first carrier shaft (5.3), exactly one of the first sun shaft (5.1), the first ring gear shaft (5.2), or the first carrier shaft (5.3) of the first planetary gear set (5) being rotationally fixedly connected to exactly one of the first output shaft (4.1) or the second output shaft (4.2);
a second planetary gear set (8), the second planetary gear set (8) having a second sun shaft (8.1), a second ring gear shaft (8.2), and a second carrier shaft (8.3), exactly one of the second sun shaft (8.1), the second ring gear shaft (8.2), or the second carrier shaft (8.3) of the second planetary gear set (8) being rotationally fixedly connected to exactly one of the first output shaft (4.1) or the second output shaft (4.2);
an oil catchment device (6) rotationally fixedly connected to the first carrier shaft (5.3); and
an oil feeding device (7) arranged on a stationary component and defining at least one channel (9) for feeding lubricant to the oil catchment device (6) via non-rotating components.

17. The differential transmission (1) of claim 16, wherein the oil catchment device (6) comprises at least one at least partially circumferential ring element.

18. The differential transmission (1) of claim 16, wherein the oil feeding device (7) is at least partially integrated in the stationary component.

19. The differential transmission (1) of claim 16, wherein the at least one channel (9) is defined by at least one bore in the stationary component.

20. The differential transmission (1) of claim 16, wherein the first planetary gear set and the second planetary gear set are arranged rotatably about an axis of rotation (A), the at least one channel (9) being at least partially defined in the stationary component substantially obliquely in a radial direction relative to the axis of rotation (A).

21. The differential transmission (1) of claim 16, wherein the first planetary gear set and the second planetary gear set are arranged coaxially to an axis of rotation (A), the at least one channel (9) being at least partially defined in the stationary component substantially in an axial direction relative to the axis of rotation (A).

22. The differential transmission (1) of claim 16, wherein the oil feeding device (7) is fluidly connected to a pump (10), the pump (10) feeding lubricant into the oil feeding device (7).

23. The differential transmission (1) of claim 16, wherein the oil feeding device (7) is fluidly connected to a catchment channel (11), the catchment channel (11) feeding lubricant into the oil feeding device (7).

24. The differential transmission (1) of claim 16, wherein the oil feeding device (7) defines an annular channel (12) for receiving and distributing lubricant.

25. The differential transmission (1) of claim 24, wherein the annular channel (12) is fluidly connected to the at least one channel (9) and at least one lubricating bore at the second planetary gear set (8).

26. The differential transmission (1) of claim 16, wherein the oil feeding device (7) defines at least one restriction (13).

27. The differential transmission (1) of claim 16, wherein the first planetary gear set (5) comprises helically toothed planetary gears (5.4),
wherein the oil feeding device (7) is configured to guide the lubricant into helical toothing of the helically toothed planetary gears (5.4),
wherein the helical toothing is configured to guide the lubricant from one frontal side of the first planetary gear set (5) to an opposite frontal side of the first planetary gear set (5).

28. The differential transmission (1) of claim 16, wherein the oil feeding device (7) is configured to spray the lubricant at least through the first planetary gear set (5) from one side of the first planetary gear set (5) onto an opposite side of the first planetary gear set (5).

29. A drive unit, comprising:
an electric machine (3); and
the differential transmission (1) of claim 16.
